(19) United States
(12) Patent Application Publication
(10) Pub. No.: US 2007/0094906 A1
(43) Pub. Date: May 3, 2007

(54) Lightweight sign suitable for outdoor advertising

(76) Inventors: Melvin L. Milligan, Edmond, OK (US); Steven T. Lehman, Spring, TX (US)

Correspondence Address: STREETS & STEELE, 13831 NORTHWEST FREEWAY, SUITE 355, HOUSTON, TX, 77040, US

(21) Appl. No.: 11/263,789

(22) Filed: Oct. 31, 2005

(51) Int. Cl. G09F 17/00

(52) U.S. Cl. 40/604

(57) ABSTRACT

A sign securable to a pair of adjacent vertical structures. The sign comprises a corrugated plastic sheet or board having horizontal flutes and opposing faces, wherein the sheet is foldable to form a display panel spanning between the pair of structures and directed outward. The sheet has hinged panels on each end of the display panel that are foldable away from the first face of the display panel to form channels that receive a vertical structure. Each of the panels is delineated by a fold line running transverse to the flutes and extending across the entire sheet. Specifically, each fold line has spaced apart collinear scores cut through the first face and extending at least half the distance through the thickness of the flutes to facilitate folding. The foldable sign includes at least one fastener for coupling the hinged panels in the channel formation.

### BACKGROUND OF THE INVENTION

1. Field of the Invention

The present invention relates to lightweight signs for attachment to a pair of adjacent vertical supports.

2. Background of the Related Art

Signs of all types are pervasive in our modem culture. Examples of signs encountered routinely include road signs providing instructions and directions to drivers, construction signs notifying visitors of necessary precautions, permanent signs for business identification, and advertising signs informing customers about product features or pricing. Each of these types of signs, as well as other types of signs not mentioned, are designed in consideration of various parameters, such as environmental conditions, expected life, installation space, project budget, size required, and time to install.

Signs that are suitable for use outdoors must be particularly well built in order to withstand any number of prevailing weather conditions that may exist. Accordingly, many outdoor signs are made of metal, brick, or molded plastic that are generally weatherproof and sufficiently sturdy to provide a reliable display and avoid the need for frequent replacement. Still, it is generally desirable for the sign to draw attention and be attractive. However, simultaneously accomplishing these objectives can be an expensive proposition.

For permanent signs identifying a business, the investment in a substantial sign is warranted. However, on the other end of the spectrum, advertising a sale item for a limited time period can boost sales, but the potential return does not justify building a dedicated sign. One approach is the construction of a permanent sign structure with removable lettering allowing the content of the sign to be changed as needed. Unfortunately, these signs are frequently limited to changes of text and are prone to user mistake or the eventual loss of certain text characters. Other approaches for providing limited-time advertising may take the form of a wall poster, window decal or shelf display. Unfortunately, most of these inexpensive signs are designed for controlled indoor conditions and do not perform well for outdoor use.

Accordingly, there is still a need for improved designs of signs that are suitable for outdoor advertising without substantial investments of money, time and space. It would be desirable to have a sign that could display modem text and graphics without limitation. It would also be desirable to have a sign that could be efficiently shipped and stored, yet facilitate quick and easy installation. Furthermore, it would be quite desirable for the sign to be lightweight and securable to existing structures.

### SUMMARY OF THE INVENTION

The present invention provides a sign securable to a pair of adjacent vertical structures, such as bollards. The sign comprises a corrugated plastic sheet or board having horizontal flutes and first and second opposing faces. The corrugated plastic sheet is foldable to form a display panel spanning between the pair of vertical structures. The sheet is positioned with the first face having a display directed away from the vertical structures. The sheet provides a set of at least two hinged panels on each end of the display panel, wherein each set of hinged panels is foldable away from the first face of the display panel to form a channel adjacent the second face. Each of the channels thus formed is adapted to receive one of the pair of vertical structures. Advantageously, each of the panels is delineated by a fold line running transverse to the flutes and extending across the entire sheet. While each fold line may include a score cut substantially across the face of the sheet, it is preferable that each fold line has a series of spaced apart collinear scores cut through the first face and extending at least half the distance through the thickness of the flutes to facilitate folding along the fold line. In order to couple the hinged panels in the channel formation, the foldable sign includes at least one fastener.

In one embodiment, the sign comprises a plurality of fasteners coupling a distal end of each set of hinged panels back to the display panel. Preferably, the display panel and the distal end of each set of hinged panels will include precut holes for looping a locking strap fastener therethrough. Further, the display panel and the distal end of each set of hinged panels are preferably coupled at two or more elevations. An optional feature includes providing precut holes at one or more of the elevations in sets of four or more horizontally spaced holes allowing selective use of holes aligning with one of the vertical structures. The adjacent vertical structures are most preferably bollards, but may include other pairs of adjacent vertical support structures.

In another embodiment, the at least one fastener secures a distal end of one set of hinged panels to a distal end of the other set of hinged panels. Preferably, the distal ends of each set of hinged panels will include precut holes for looping a locking strap fastener therethrough. Alternatively, the panels may be secured together using a fastener made solely from the material of the hinged panels themselves.

If the vertical structures that might be encountered have a range of different characteristics selected from the distance between vertical structures, width of the vertical structures, shapes of the vertical structures, and combinations thereof, then each set of hinged panels may optionally include three or more hinged panels that are selectively foldable around the structures.

In a further embodiment, the foldable sign is reversible by cutting the scores through the entire thickness of the sheet. The sign is reversed by removing the fasteners, positioning the sheet with the second face directed away from the vertical structures, folding each set of the hinged panels away from the second face of the display panel to form channels adjacent the first face, and securing the hinged panels in the reversed channel formation.

The embodiments of the present invention can provide a number of advantages over other signs. For example, the unitary seamless sheet design makes the signs strong, while allowing shipment and storage in a near zero-waste space configuration. Furthermore, the design is simple. The embodiments disclosed may generally include further elements or components, but will typically consist essentially of the corrugated plastic sheet described and the fasteners. No complex assembly or collection of parts in necessary. Furthermore, the sheets facilitate the use of modern printing methods for creating the display. These features keep the cost of the sign low and meet a strong and long-felt need for a lightweight sign suitable for outdoor use.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of a sign before it is folded or made up.

FIG. 2 is a perspective view of the sign after being folded once on each end of the sign.

FIG. 3 is a perspective view of the sign after being folded twice on each end of the sign and secured in the desired configuration with fasteners.

FIG. 4 is a perspective view of the sign installed and secured to a pair of bollards typical of those used to protect gasoline pumps.

FIGS. 5(A) and 5(B) are top views of the installed sign, illustrating how the sign can be secured to vertical support structures, such as bollards, even if the spacing of the structures is different between installations.

FIG. 6 is a cross-sectional side view of the sign of FIG. 5.

FIG. 7 is a perspective view of a fold line that includes a series of spaced apart collinear scores cut through the first face and extending at least half the distance through the thickness of the flutes to facilitate folding along the fold line.

FIG. 8(A)-8(C) are schematic top, assembled back and unassembled back views of a further embodiment of the foldable sign in which the sets of hinged panels attach to each other without using separate fasteners.

FIG. 9 is a schematic top view of yet another embodiment of the sign, wherein the sets of hinged panels are adhesively secured back to the second face of the sign.

### DETAILED DESCRIPTION OF THE INVENTION

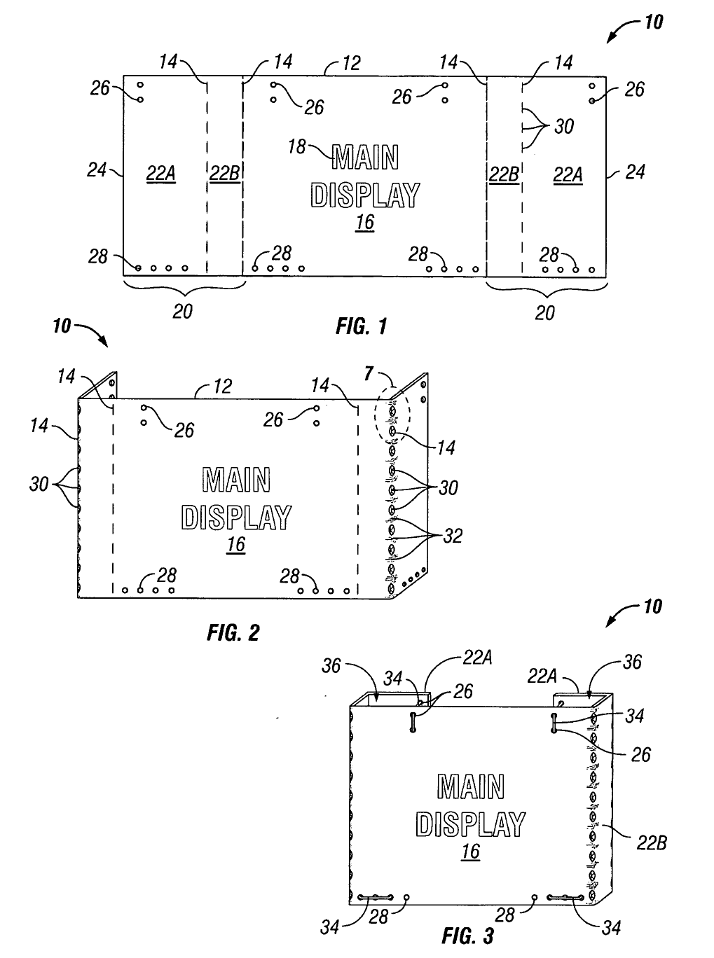

FIG. 1 is a plan view of a first face of a sign 10 before it is folded or made up. The sign is made from a unitary sheet 12 of corrugated plastic. The sheet 12 may be formed or cut into any desirable shape, but a rectangle is preferred. The sheets are easily stacked in a manner that almost zero space is wasted. The sheet 12 includes cut or scored fold lines 14 that delineate the sheet into panels. Specifically, the sheet 12 provides a display panel 16 receives a desired text or graphic display 18 (marked “MAIN DISPLAY”). The sheet 12 also includes a set of hinged panels 20, on both sides of the display panel 16 (as shown, to the right and left). Each set 20 includes two or more hinged panels (22A, 22B, and more) including a hinged panel that is the distal panel having a distal end 24. According to certain preferred embodiments, the sheet 12 may have a number of precut holes, including a set of pre-cut holes 26 at an upper elevation and a set of precut holes 28 at a lower elevation. These pre-cut holes are used for securing the sign to a pair of adjacent vertical support structures as will be described below.

FIG. 2 is a perspective view of the sign 10 after being folded once on each end of the sign. The order in which the fold lines 14 are folded is not particularly important. Here, the sign is illustrated with the most distal hinged panel 22A being folded back away from the front face of the sheet 12 that contains the display 18. As shown, the fold is made neatly and precisely along the fold line 14 that was created by a series of collinear scores 30 in the face of the sheet 12. Between each of the scores or cuts 30, the sheet 12 is locally stressed as shown by the lines 32. However, the sheet 12 is made of plastic and plastic compositions typically resist tension. It is preferred that the corrugations of the sheet 12 form parallel flutes and that the sign 10 is made with the flutes or other corrugations running horizontally. In this configuration, the uncut or unscored flutes that extend between the scores 30 remain intact and add strength to the folded corner.

FIG. 3 is a perspective view of the sign 10 after being folded twice on each end of the sign and secured in the desired configuration with fasteners 34. Each of the fold lines 14 have been folded back away from the front face of the display panel 16 containing the display 18 such that each set of hinged panels 20 forms a channel 36 adjacent the back face of the display panel 16 (opposite the front face shown). The panels 16, 22A, 22B, etc. are secured in this configuration by fasteners of any suitable type, but are shown using wires, straps or bands. A most preferred fastener is a locking strap fastener. The fasteners 34 are passed through the pre-cut holes in both the display panel 16 and the distal panels 22A and closed into a loop in the typical manner. It should be recognized that the sign 10 may be configured as shown in FIG. 3 before placing the sign on vertical support structures, or the sign may be configured in place around the structures. Accordingly, it is not necessary for the channel to fit tightly around the support structures as long as the structures extend into the channels 36 and prevent the sign from falling over or drifting out of place. Still, it may be preferably to draw up any slack in the fasteners once the configured sign 10 has been position around the support structures so that the portions of the flexible panels 16, 22A, 22B that form the channel 36 are slightly flexed. With a slight flex in these panels, the channel will hug the support structure and prevent movement of the sign during normal conditions.

In the embodiment shown in FIG. 3, fasteners 34 are secured through pre-cut holes 26 at an upper elevation and through pre-cut holes 28 at a lower elevation (in this view, some of the holes some in FIGS. 1 and 2 are hidden behind the display panel 16). Fastening the panels at more than one place provides a more secure configuration of the sign 10 as well as providing more uniform flexing of the panels if the panels are to be installed firmly against the support structures. Still further, the pre-cut holes 28 at the lower elevation are preferably provided in greater number than will be utilized in a single installation of the sign. The holes 28 are disposed in a generally horizontal row so that the fastener 34 passing therethrough can loop around the support structure as it extends between the display panel 16 and the distal hinged panel 22A. Accordingly, the fastener not only secures the two panels together (front to back), but also secures the sign to the support structures in a manner that prevents shifting (as shown, right to left) whether or not the support structure is disposed exactly at the deepest part of the channel 36. Preferably, the pre-cut holes 28 are provided in sufficient number and spacing so that there are holes available to accommodate a range of possible spacings between support structures that will be encountered in the field. In addition, the number and spacing of the holes can engage support structures of various widths or diameters by selecting the appropriate holes. As shown, the fastener 34 loops through two holes 28 on the display panel 16, but one hole was intentionally skipped between those two holes to approximate the width of the structure. Adjacent holes may be used for narrower support structures or additional holes may be skipped for even wider support structures.

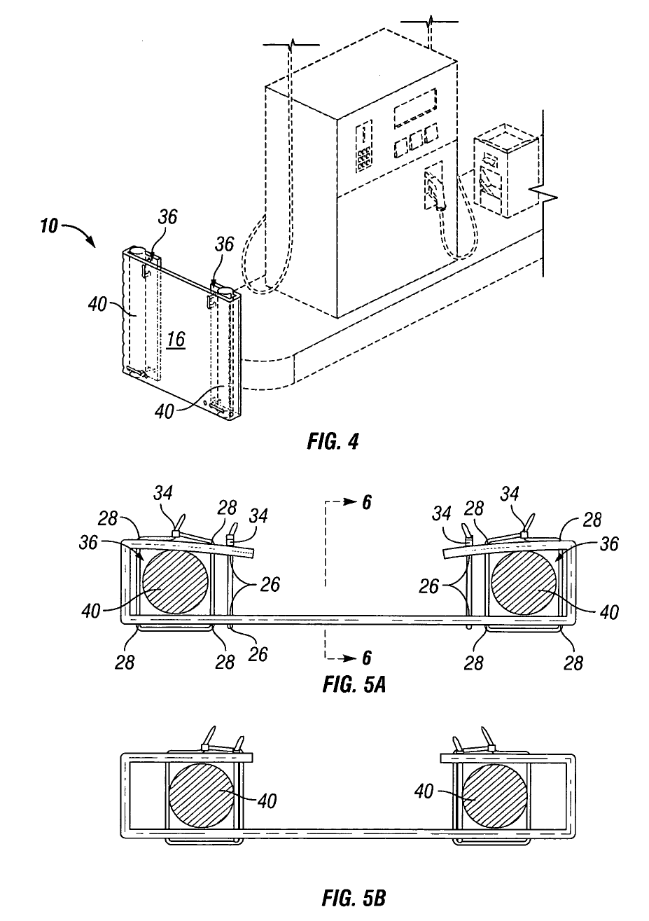

FIG. 4 is a perspective view of the sign 10 installed and secured to a pair of bollards 40 typical of those used to protect gasoline pumps. A bollard is a pole used to block a path to vehicles. Conventional bollards are constructed in various shapes, sizes and spacings, but frequently comprises a pair of adjacent vertical support structures. Notably, some pairs of vertical bollards may be coupled, such as at the top to produce a single inverted “U” shaped bollard. Whether the pair of support structures 40 are provided by separate bollards or a single bollard, the support structures are still received within the channels 36 formed by the foldable sign 10.

FIGS. 5(A) and 5(B) are top views of the installed sign 10 of FIG. 4, illustrating how the sign can be secured to vertical support structures 40, such as bollards, even if the spacing of the structures is different between installations. In FIG. 5(A), the structures 40 are received deep into the channels 36 and the fasteners 34 are secured through a pair of the lower elevation holes 28 that are widely spaced (as shown in FIG. 3). In FIG. 5(B), the structures 40 are significantly closer together, such that the structures are received shallow within the channels 36. Accordingly, the fasteners 34 that secure the sign at the lower elevation are secured through a different pair of holes in the row of holes 28 (See FIGS. 1 through 4) that are closer together (for example, the unused pair of holes 28 is FIG. 3). Because the distal hinged panel 22A was wide enough, and formed a channel 36 that was deep enough, the fasteners 34 in the upper elevation holes 26 do not require adjustment. While this is the preferred arrangement to simplify installation and possibly to loop around any horizontal structures (for example, in an inverted “U” shaped bollard), it is possible to arrange the upper elevation holes 26 in the same or similar number and configuration as the lower elevation holes 28. In addition, it should be recognized that the hinged panel 22B, or some number of other panels, approximate the thickness of the support structure. If wide variations exist in the width of the support structures, then the sheet 12 may be made with an excess number of scored fold lines in the region that will form the channel, so that appropriate fold lines are available and selectable in the field in order to fold around the support structure.

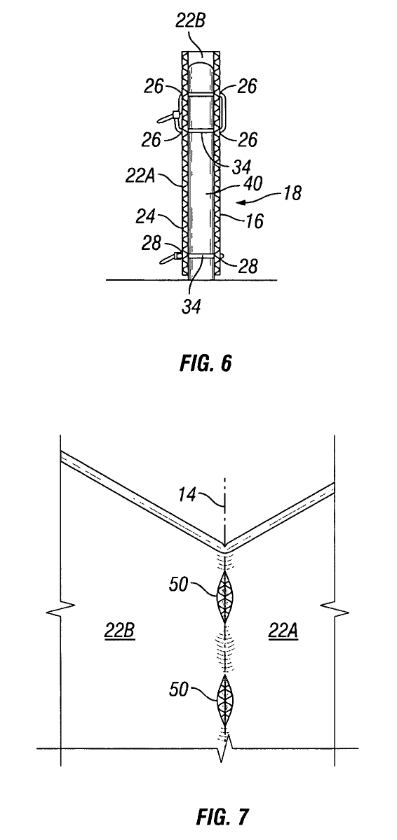

FIG. 6 is a cross-sectional side view of the sign 10 of FIG. 5. The front display panel 16 is disposed on one side of the support structure 40 with the display 18 directed away from the structure for viewing. The hinged panel 22B passes around (behind) the structure 40 and the distal hinged panel 22B is disposed on the side of the support structure opposite the display panel 16. As previously described, a fastener 34 is secured through the lower elevation holes 28 (a pair of holes in the display panel 16 and a pair of holes in the distal hinged panel 22A) and a fastener 34 is secure through the upper elevation holes 26 (a pair of holes in the display panel 16 and a pair of holes in the distal hinged panel 22A). The cross-sectional view is shown from the position indicated in FIG. 5. Whereas only the display panel 16 is truly shown in cross-section, the distal edge 24 of the distal hinged panel will typically have an exposed cross-section. Accordingly, both of the panels 16, 22A shown in FIG. 6 illustrate the construction of a corrugated plastic sheet or board. Each sheet or panel of the corrugated material has opposing faces with the internal structure defined by a plurality of “flutes.” The design and production of such a corrugated plastic sheet and the flutes within the sheet is well known in the art. However, the panels are shown here in the preferred orientation having the flutes run horizontally between the fold lines. This orientation is believed to provide the sign with increased strength of the display panel, since the flutes span between the support structures.

FIG. 7 is a perspective view of one part of a fold line 14 that includes a series of spaced apart collinear scores 50 cut through the first face and extending at least half the distance through the thickness of the flutes to facilitate folding along the fold line. The series of scores or cuts 50 delineates the two adjacent panels 22B, 22A and enables the otherwise rigid sheet to be folded easily and neatly along the intended fold line 14. Upon folding, the scores 50 expose a number of the internal flutes. Experience has shown that the scores or cuts may extend entirely through the sheet without jeopardizing the integrity of the sign, so long as there is some material along the fold line 14 that remains intact.

Furthermore, making the scores or cuts extend through the entire thickness of the sheet may facilitate the sign being reversible. Since the original flat sheet 12 (See FIG. 1) is preferably symmetrical about a vertical centerline (running from top to bottom in FIG. 1), there is nothing to prevent the back face from having a display of its own. Then, the user can select which display to exhibit and can easily switch between the two displays by releasing the fasteners, inverting the panels by folding them in the opposite direction, and refastening the sign. The reversibility is preferably facilitated by incorporating a re-usable fastener or strap (such as grommets and arrows) to allow for quick and non-destructive changes in the face that is outwardly directed.

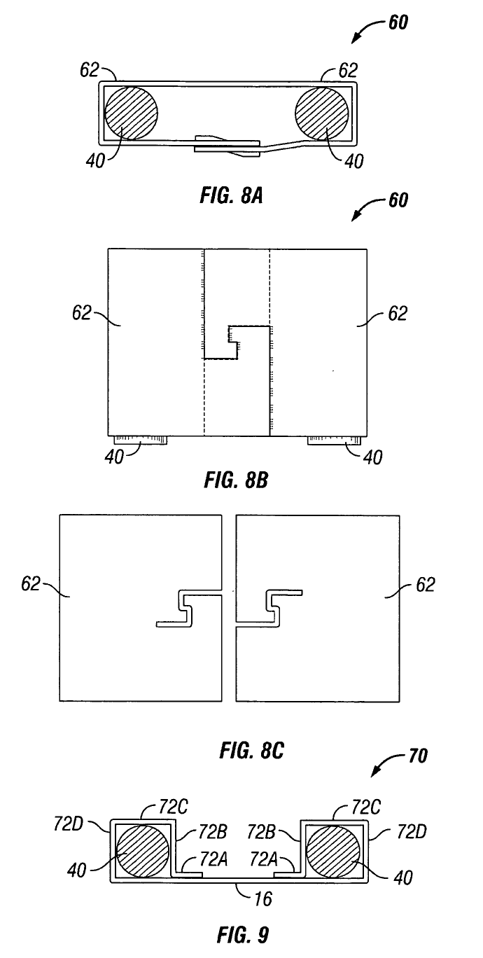

FIGS. 8(A) and 8(B) are schematic top and back views, respectively, of a further embodiment of a foldable sign 60 that is identical in most respects to sign 10, but in which the distal hinged panels 62 attach to each other without using separate fasteners. The distal hinged panels may utilize any of a variety of fasteners, but preferably the fasteners are integral to the sheet, such as a pair of cooperating slots cut into the sheet itself. Specifically, the integral fasteners may be locking tabs and slots or interlocking tabs. For clarity, FIG. 8(C) shows the slots cut into these two distal hinged panels 62 prior to being fastened. Alternatively, this sign can be secured with separate fasteners as previously disclosed, or with other more permanent types of fasteners, such as staples. Accordingly, a sign may have hinged panels secured together and folded prior to shipment to the installation site and the sign still folded flat. Still further, such a pre-folded sign may still include strap-type fasteners, for example, for securing the sign to the adjacent vertical structures in the field. In the embodiments that completely surround both of the adjacent vertical structures, as does sign 60 in FIGS. 8(A) and 8(B), there may be three hinged panels on one side of the display and one hinged panel on the other side of the display, such that the panels overlap and are secured together to one side of the display panel rather than behind the display panel.

FIG. 9 is a schematic top view of yet another embodiment of a foldable sign 70, that is identical in most respects to sign 10, but wherein each set of hinged panels includes four fold lines 14 delineating four panels 72A-72D and the distal panel 72A is secured directly to the back of the display panel. Here, the fastener is preferably a grommet (and arrow), snap or screw, but could also be an adhesive or hook and loop fastener.

The foregoing description is intended for purposes of illustration only and should not be construed in a limiting sense. The scope of this invention should be determined only by the language of the claims that follow. The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

What is claimed is:

1. A sign securable to a pair of adjacent vertical structures, comprising:
a corrugated plastic sheet having horizontal flutes and first and second opposing faces, wherein the sheet is foldable to form a display panel spanning between the pair of vertical structures with the first face having a display directed away from the vertical structures and a set of at least two hinged panels on each end of the display panel, each set of hinged panels foldable away from the first face of the display panel to form a channel adjacent the second face adapted to receive one of the pair of vertical structures, each of the panels delineated by a fold line running transverse to the flutes and extending across the entire sheet; and
at least one fastener for coupling the hinged panels in the channel formation.

2. The sign of claim 1, wherein the at least one fastener comprises a plurality of fasteners coupling a distal end of each set of hinged panels back to the display panel.

3. The sign of claim 2, wherein the display panel and the distal end of each set of hinged panels include precut holes for looping a locking strap fastener therethrough.

4. The sign of claim 2, wherein the display panel and the distal end of each set of hinged panels are coupled at two or more elevations.

5. The sign of claim 4, wherein the display panel and the distal end of each set of hinged panels include precut holes at the two or more elevations for looping a locking strap fastener therethrough.

6. The sign of claim 5, wherein the precut holes at one or more of the elevations are provided in sets of four or more horizontally spaced holes allowing selective use of holes aligning with one of the vertical structures.

7. The sign of claim 1, wherein the pair of adjacent vertical structures are bollards.

8. The sign of claim 1, wherein the sheet is seamless.

9. The sign of claim 1, wherein the at least one fastener secures a distal end of one set of hinged panels to a distal end of the other set of hinged panels.

10. The sign of claim 9, wherein the distal ends of each set of hinged panels include precut holes for looping a locking strap fastener therethrough.

11. The sign of claim 9, wherein the at least one fastener is made solely from the hinged panels.

12. The sign of claim 1, wherein each set of hinged panels includes three or more hinged panels selectively foldable around pairs of vertical structures having a range of different characteristics selected from the distance between vertical structures, width of the vertical structures, shapes of the vertical structures, and combinations thereof.

13. The sign of claim 1, wherein the scores are cut through the entire thickness of the sheet, and wherein the foldable sign is reversible by removing the fasteners, positioning the sheet with the second face directed away from the vertical structures, folding each set of the hinged panels away from the second face of the display panel to form channels adjacent the first face, and securing the hinged panels in the reversed channel formation.

14. The sign of claim 1, wherein the at least two predefined fold lines span a distance approximating the thickness of the vertical structures.

15. The sign of claim 1, characterized in that the sheets are stackable with no waste space therebetween.

16. The sign of claim 1, wherein the vertical bollards are integrated with a crossbar, and wherein the fasteners are coupled around the crossbar to support the sheet off the ground.

17. The sign of claim 1, wherein each fold line having a series of spaced apart collinear scores cut through the first face and extending at least half the distance through the thickness of the flutes to facilitate folding along the fold line

18. A cut and scored sign securable to a pair of adjacent vertical structures, consisting essentially of:
a corrugated plastic sheet having horizontal flutes and first and second opposing faces, wherein the sheet is foldable to form a display panel spanning between the pair of vertical structures with the first face having a display directed away from the vertical structures and a set of at least two hinged panels on each end of the display panel, each set of hinged panels foldable away from the first face of the display panel to form a channel adjacent the second face adapted to receive one of the pair of vertical structures, each of the panels delineated by a fold line running transverse to the flutes and extending across the entire sheet; and
at least one fastener for coupling the hinged panels in the channel formation.

19. The sign of claim 18, wherein the at least one fastener comprises a plurality of fasteners coupling a distal end of each set of hinged panels back to the display panel.

20. The sign of claim 19, wherein the display panel and the distal end of each set of hinged panels include precut holes for looping a locking strap fastener therethrough.

21. The sign of claim 19, wherein the display panel and the distal end of each set of hinged panels are coupled at two or more elevations.

22. The sign of claim 21, wherein the display panel and the distal end of each set of hinged panels include precut holes at the two or more elevations for looping a locking strap fastener therethrough.

23. The sign of claim 1, wherein each fold line having a series of spaced apart collinear scores cut through the first face and extending at least half the distance through the thickness of the flutes to facilitate folding along the fold line

24. A method, comprising:
printing an image on a first face of a corrugated plastic sheet;
scoring the first face of the corrugated plastic sheet to form a plurality of fold lines;
placing the sheet in a folded condition by folding the sheet along the fold lines away from the first face to form an outwardly directed display panel containing the printed image and a plurality of panels hingedly secured to the display panel, and
securing the plurality of hinged panels in the folded condition receivable about a pair of adjacent vertical structures.

25. The method of claim 24, wherein the pair of adjacent vertical structures are bollards.

26. The method of claim 24, wherein the corrugated plastic sheet has horizontal flutes that run substantially perpendicular to the printed image and the fold lines,

27. The method of claim 25, wherein the step of folding the sheet forms two opposing channels for receiving a pair of adjacent bollards.

28. The method of claim 24, further comprising:
Positioning the folded panels about the pair of adjacent vertical structures.

29. The method of claim 24, wherein the sheet is placed in the folded condition before shipping to the site of the adjacent vertical structures.

30. The method of claim 24, wherein the sheet is placed in the folded condition after shipping to the site of the adjacent vertical structures.
